(19) United States
(12) Patent Application Publication
(10) Pub. No.: US 2011/0171067 A1
(43) Pub. Date: Jul. 14, 2011

(54) GAS SENSITIVE STRUCTURE AND COMPONENT INCLUDING THE SAME

(75) Inventor: Cord Mueller, Middletown, CT (US)

(73) Assignee: KONINKLIJKE PHILIPS ELECTRONICS N.V., EINDHOVEN (NL)

(21) Appl. No.: 12/937,021

(22) PCT Filed: Apr. 2, 2009
(86) PCT No.: PCT/IB2009/051401

§ 371 Date: Feb. 18, 2011

Related U.S. Application Data
(60) Provisional application No. 61/043,146, filed on Apr. 8, 2008.

(51) Int. Cl. G01N 21/76

(52) U.S. Cl. 422/52

(57) ABSTRACT

A component of a system configured to monitor one or more gaseous analytes. In one embodiment, the component comprises a conduit and a gas sensitive film. The conduit is formed to enable a flow of gas therethrough. The gas sensitive film is disposed in communication with the flow of gas, and is sensitive to one or more gaseous analytes within the flow of gas. In some instances, the film comprises a dye and a polymer matrix. The dye is sensitive to the one or more gaseous analytes. The polymer matrix carries the dye, is porous, and is formed such that the film has (i) a dynamic range of at least from about 20% to about 90% concentration of the one or more gaseous analytes, and (ii) a response time over at least a portion of the dynamic range of less than about 80 milliseconds.

### BACKGROUND OF THE INVENTION

1. Field of the Invention

The present invention pertains to gas sensitive structures that enable determinations of the concentration of one or more gaseous analytes, and components of systems for determining such concentrations.

2. Description of the Related Art

Sensors including a luminescable medium that measure one or more aspects of the luminescence of the luminescable medium in order to determine information related to an analyte in a body of gas in contact with the luminescable medium are known. Some conventional luminescable media include a gas sensitive film that comprises a polymeric film and a luminescable dye bound in the polymeric film. In these conventional luminescable media, various sensor characteristics of the luminescable media, e.g., response time and dynamic range, are a function of a degree of cross-linking within the polymer and/or molecular weight. Generally, a degree of cross-linking and/or molecular weight that increases the dynamic range of a luminescable media will also tend to increase the response time of the luminescable media. As a result, to enhance the dynamic range of luminescable media, the response time of the luminescable media may have to be degraded. Similarly, to provide luminescable media with an enhanced response time, the dynamic range of the luminescable media may be inhibited.

### SUMMARY OF THE INVENTION

One aspect of the invention relates to a component of a system configured to monitor one or more gaseous analytes. In one embodiment, the component comprises a conduit and a gas sensitive film. The conduit is formed to enable a flow of gas therethrough. The gas sensitive film is disposed in communication with the flow of gas, and is sensitive to one or more gaseous analytes within the flow of gas. In some instances, the film comprises a dye and a polymer matrix. The dye is sensitive to the one or more gaseous analytes. The polymer matrix carries the dye, is porous, and is formed such that the film has (i) a dynamic range of at least from about 20% to about 90% concentration of the one or more gaseous analytes, and (ii) a response time over at least a portion of the dynamic range of less than about 80 milliseconds.

Another aspect of the invention relates to a gas sensitive structure In one embodiment, the structure comprises a substrate and a film. The film is disposed on the substrate, and is sensitive to one or more gaseous analytes. In some instances the film comprises a polymer matrix and a dye. The polymer matrix has a porosity greater than 10%. The dye is carried by the polymer matrix, and is sensitive to the one or more gaseous analytes.

Another aspect of the invention relates to a gas sensitive structure. In one embodiment, the structure comprises a substrate and a film. The film is disposed on the substrate and is sensitive to one or more gaseous analytes. In some instances, the film comprises a dye and a polymer matrix. The dye is sensitive to the one or more gaseous analytes. The polymer matrix carries the dye, and is formed such that the film has (i) a dynamic range of at least from about 20% to about 90% concentration of the one or more gaseous analytes, and (ii) a response time over at least a portion of the dynamic range of less than about 80 milliseconds.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIGS. 1A and 1B schematically illustrates a system configured to determine information related to one or more analytes in a body of gas according to one embodiment of the invention;

FIG. 2 schematically illustrates a configuration of a sensor configured to determine information related to one or more analytes in a body of gas, according to one embodiment of the invention;

FIG. 3 schematically illustrates a configuration of a sensor configured to determine information related to one or more analytes in a body of gas, according to one embodiment of the invention; and

FIG. 4 schematically illustrates a luminescable medium, in accordance with one embodiment of the invention.

### DETAILED DESCRIPTION OF THE EXEMPLARY EMBODIMENTS

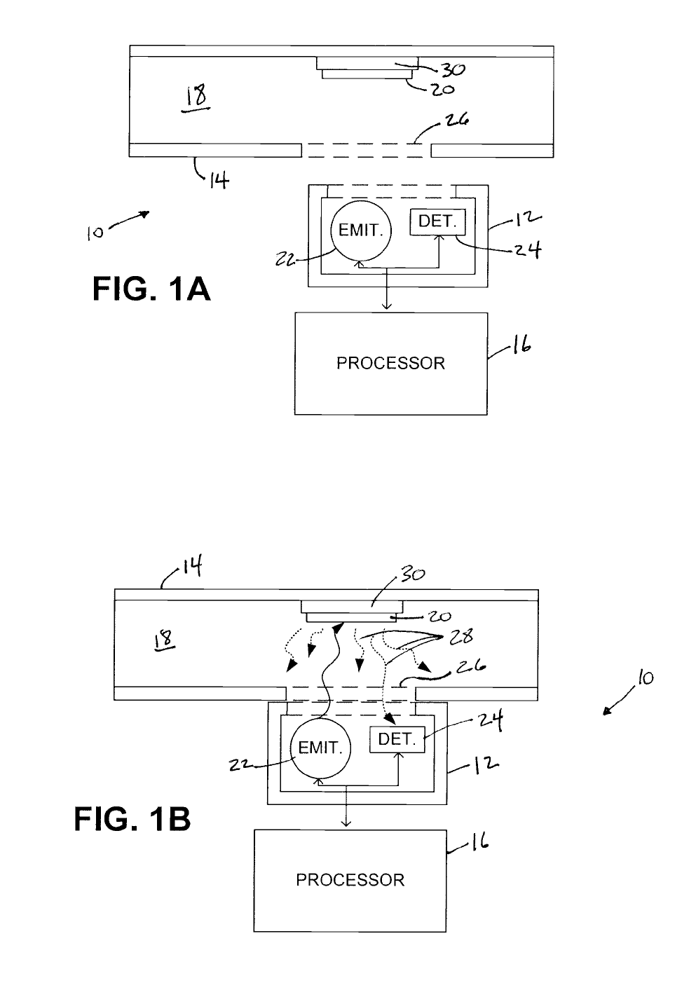

Turning to FIG. 1A, a system 10 configured to determine information related to one or more analytes in a body gas is illustrated. System 10 includes a sensor 12, a conduit 14, and a processor 16. Sensor 12 and conduit 14 can, in one embodiment, be removably coupled to each other. FIG. 1A illustrates conduit 14 uncoupled from sensor 12.

FIG. 1B schematically illustrates system 10 when sensor 12 and conduit 14 are coupled together. Conduit 14 provides a flow path 18 through which a body of gas may pass. If sensor 12 is coupled to conduit 14 (e.g., as illustrated in FIG. 1B), sensor 12 is operable to generate an output signal that is provided to processor 16 via an operative communication link (e.g., a wired link, a wireless link, a discrete link, a link via a network, etc.) therebetween. Based on the output signal generated by sensor 12, processor 16 determines information related to one or more properties of one or more analytes included in a body of gas disposed within flow path 18.

In one embodiment, conduit 14 may be coupled with another conduit or tubing that delivers gas to and/or receives gas from conduit 14. In which case, conduit 14 is typically referred to as an “airway adapter”. In a more particular example, conduit 14 forms part of a fluid circuit that is part of a gas delivery system. For instance, the gas delivery system may be designed to provide breathing therapy to a patient. In such instances, the fluid circuit, of which conduit 14 is a part, delivers gas to (e.g., from a gas source and/or flow generator), and/or receives gas from, a patient interface appliance configured to communicate with an airway of the patient. Some examples of the patient interface appliance may include, for example, an endotracheal tube, a nasal cannula, a tracheotomy tube, a mask, or other patient interface appliances. The present invention is not limited to these examples, and contemplates determination of analytes in any body of gas.

In one embodiment, in which conduit 14 forms a component of a system configured to monitor one or more gaseous analytes in a flow of gas being delivered through a fluid circuit in which conduit 14 is disposed, conduit 14 is selectively removable from the fluid circuit. This will enable conduit 14 to be removed and/or replaced as need. For example, over time, the performance of the system configured to monitor one or more gaseous analytes of which conduit 14 is a component may degrade if conduit 14 and/or some element included in or carried by conduit 14 is not replaced or renewed (e.g., luminescable medium 20, discussed further below).

As can be seen in FIGS. 1A and 1B, in one embodiment, conduit 14 carries a luminescable medium 20. In one embodiment, sensor 12 includes an emitter 22, and a photosensitive detector 24.

It should be appreciated that a variety of mechanisms may be implemented to removably couple sensor 12 and conduit 14. In some embodiments a seating area is provided on an outer surface of a housing that houses sensor 12. The seating area being adapted to securely receive conduit 14. For example, sensor 12 and conduit 14 may be coupled in the manner described in U.S. Pat. No. 6,616,896 to Labuda et al., entitled “OXYGEN MONITORING APPARATUS,” and issued September 9, 2003 (hereafter “the '896 patent”), or in the manner described in U.S. Pat. No. 6,632,402 to Blazewicz et al., entitled “OXYGEN MONITORING APPARATUS,” and issued Oct. 14, 2003 (hereafter “the '402 patent”). Further, both of these references describe sensors that (1) include components similar to some or all of emitter 22, photosensitive detector 24, and/or luminescable medium 20, and (2) determine information related to one or more analytes in a body of gas in a manner similar to sensor 12 and processor 16. Both the '402 patent and the '896 patent are hereby incorporated, in their entireties, into this disclosure by reference. These examples are not intended to be limiting, and it should be appreciated that any suitable method for coupling sensor 12 and conduit 14 can be used. In addition, in another embodiment, sensor 12 and conduit 14 are permanently connected to one another, or at least not readily uncoupled.

When sensor 12 and conduit 14 are coupled, emitter 22 emits electromagnetic radiation that is directed onto luminescable medium 20. As will be discussed further below, the electromagnetic radiation emitted by emitter 22 includes electromagnetic radiation with a wavelength that causes luminescable medium 20 to luminesce. Emitter 22 may include one or more Organic Light Emitting Diodes (“OLEDs”), lasers (e.g., diode lasers or other laser sources), Light Emitting Diodes (“LEDs”), Hot Cathode Fluorescent Lamps (“HCFLs”), Cold Cathode Fluorescent Lamps (“CCFLs”), incandescent lamps, halogen bulbs, received ambient light, and/or other electromagnetic radiation sources.

In one implementation, emitter 22 includes one or more green and/or blue LEDs. These LEDs typically have high intensity in the luminescable composition absorption region of luminescable medium 20 and output smaller amounts of radiation at other wavelengths (e.g., red and/or infrared). This minimizes stray interfering light and/or photo degradation of sensor 12.

While, the present invention is by no means limited to the use of LEDs, other advantages of implementing LEDs as emitter 22 include their light weight, compactness, low power consumption, low voltage requirements, low heat production, reliability, ruggedness, relatively low cost, and stability. Also, they can be switched on and off very quickly, reliably, and reproducibly.

In some implementations, system 10 may include one or more optical elements (not shown) disposed within one or both of sensor 12 and/or conduit 14 to guide, focus, and/or otherwise process radiation emitted by emitter 22. For example, one or more lenses may collimate the radiation in a selected direction. As more particular examples, both of the incorporated '896 and '402 patents disclose the use of optical elements that process radiation emitted by an emitter similar to emitter 22. Filters and mirror are also contemplated for use in the present invention. Moreover, the present invention contemplates that the physically arrangement for the emitter and detector(s) can be any one of a variety of arrangements.

When sensor 12 and conduit 14 are coupled, the electromagnetic radiation from emitter 22 may arrive at luminescable medium 20 with a predetermined amplitude modulation (e.g., having a predetermined frequency, having a predetermined maximum and/or minimum amplitude, etc.). In one embodiment, emitter 22 may be driven to emit the electromagnetic radiation with the predetermined amplitude modulation. In another embodiment, sensor 12 may include one or more optical elements (not shown) that modulate the amplitude of electromagnetic radiation emitted by emitter 22. The one or more optical elements may include one or more periodically driven active elements (e.g., a liquid crystal stack, etc.) and/or one or more passive elements that are periodically moved into and out of an optical path of the electromagnetic radiation emitted by emitter 22 (e.g., filters, half-mirrors, etc.).

Conduit 14 may include a window 26 formed in a wall of conduit 14. Window 26 may be substantially transparent to enable electromagnetic radiation, such as the electromagnetic radiation emitted by emitter 22, to enter and/or exit the interior of conduit 14 when sensor 12 and conduit 14 are coupled. For instance, window 26 may be formed of sapphire, one or more polymers (e.g., polyethelyne, etc.), a glass, and/or other substantially transparent materials. In some embodiments (not shown), conduit 14 may include two windows similar to window 26. As is shown and described in the '402 patent, the two windows may be disposed in conduit 14 opposite from each other to enable electromagnetic radiation to pass through conduit 14. In this embodiment, photosensitive detector 24 may be positioned on an opposite side of conduit 14 from emitter 22 when sensor 12 and conduit 14 are coupled.

Luminescable medium 20 is a medium that, in response to radiation from emitter 22 and/or some other excitation energy, luminesces to emit electromagnetic radiation, indicated by wavy lines 28, in a substantially omnidirectional manner at a wavelength different from that of the electromagnetic radiation provided by emitter 22. The intensity and/or persistence of this luminesced electromagnetic radiation 28 rises and falls according to the relative amounts of one or more analytes included in the body of gas within conduit 14. In one embodiment, oxygen, carbon dioxide, one or more anesthetic agents, and/or other gaseous analytes causes a modification of the intensity and/or persistence of luminescent radiation 28 by quenching the luminescence reaction. As the concentration of the appropriate analyte(s) increases, the modification of the intensity and/or persistence of luminescent radiation 28 will increase. In some instances, the modification of the intensity and/or persistence of luminescent radiation 28 caused by an increase in concentrations of an analyte includes a reduction in the intensity and/or persistence off luminescent radiation 28. In one embodiment, luminescable medium 20 is formed as a luminescent film (e.g., as discussed below).

In the embodiment illustrated in FIGS. 1A and 1B, luminescable medium 20 is disposed in contact with, in close proximity with, or otherwise thermally coupled to a thermal capacitor 30. Thermal capacitor 30 is employed to maintain luminescable medium 20 at a substantially constant operating temperature and thereby reduce or eliminate inaccuracies in system 10 attributable to variations in the temperature of luminescable medium 20. It is be understood that the present invention contemplates using any heater or heat controlling system to maintain luminescable medium 20 at a substantially constant operating temperature in addition to or in place of thermal capacitor 30.

Photosensitive detector 24 is positioned within sensor 12 such that if sensor 12 and conduit 14 are coupled, photosensitive detector 24 receives at least a portion of luminesced electromagnetic radiation 28 from luminescable medium 20. Based on the received radiation, photosensitive detector 24 generates one or more output signals related to one or more properties of the received radiation. For example, the one or more output signals may be related to an amount of the radiation, an intensity of the radiation, a modulation of the radiation, and/or other properties of the radiation. In one embodiment, photosensitive detector 24 includes a PIN diode. In other embodiments, other photosensitive devices are employed as photosensitive detector 24. For instance, photosensitive detector 24 may take the form of a diode array, a CCD chip, a CMOS chip, a photo-multiplier tube and/or other photosensitive devices.

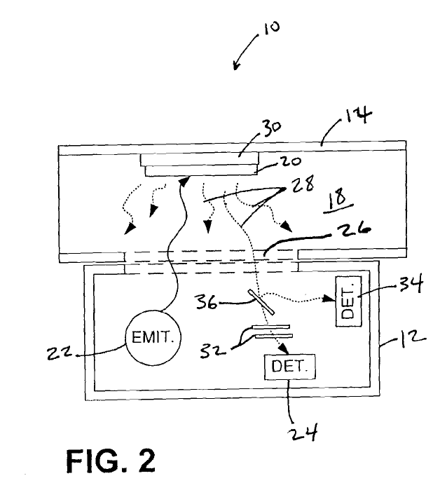

FIG. 2 schematically illustrates an embodiment of sensor 12 including photosensitive detector 24 in which one or more filter elements 32 are positioned within sensor 12 between luminescable medium 20 and photosensitive detector 24. As is described in both the incorporated '896 and '402 patents, filter elements 32 are typically designed to prevent electromagnetic radiation not emitted by luminescable medium 20 from becoming incident on photosensitive detector 24. For instance, in one embodiment, filter elements 32 are wavelength specific and permit luminescence radiation 28 to pass therethrough to become incident on photosensitive detector 24 while substantially blocking radiation with other wavelengths (e.g., ambient radiation, electromagnetic radiation emitted by emitter 22 and reflected from window 26, etc.).

In the embodiment of sensor 12 illustrated in FIG. 2, sensor 12 also includes a reference photosensitive detector 34 and a beam splitting element 36. As is described in the incorporated '896 patent, beam splitting element 36 may direct a portion of the radiation propagating toward photosensitive detector 24 onto reference photosensitive detector 34. One or more output signals generated by reference photosensitive detector 34 may be used as a reference to account for, and/or compensate for, system noise (e.g., intensity fluctuations in emitter 22, etc.) in the one or more output signals generated by photosensitive detector 24.

It should be appreciated that although filters 32, reference photosensitive detector 34, and beam splitting element 36 are shown in FIG. 2 as being disposed in sensor 12, this is for illustrative purposes. In other embodiments, some or all of beam splitting element 36, reference photosensitive detector 34, and/or one or more of filters 32 may be disposed within conduit 14.

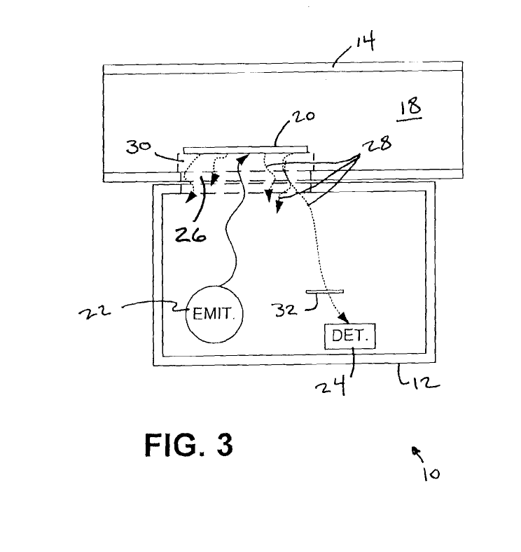

FIG. 3 schematically illustrates yet another configuration of sensor 12. In the configuration illustrated in FIG. 3, thermal capacitor 30 is at least partially translucent, and is located adjacent to window 26. In this configuration luminescable medium 20 is positioned in thermal communication with thermal capacitor 30 on an opposite side of capacitor 30 from window 26. Luminescable medium 20 is exposed to flow path 18 on a side of luminescable medium 20 that is opposite the boundary between capacitor 30 and luminescable medium 20. As can be seen, electromagnetic radiation 38 emitted by emitter 22 passes through both window 26 and thermal capacitor 30 to become incident luminescable medium 20. Luminescent radiation 28 emitted from luminescable medium 20 proceeds back through thermal capacitor 30 and window 26 to become incident on a filter element 32 and photosensitive detector 24, in substantially the same manner as is described above. As example of this configuration is disclosed in U.S. patent application Ser. No. 11/368,832, publication no. US20060145078, the contents of which are incorporated herein by reference. In some instances, thermal capacitor 30 and window 26 may be formed as a single, integral component.

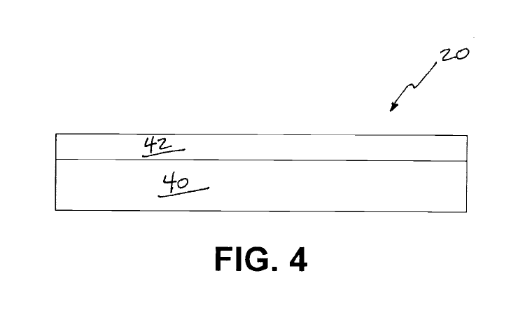

FIG. 4 schematically illustrates a side elevation view of luminescable medium 20, in accordance with one or more embodiments of the invention. As can be seen in FIG. 4, luminescable medium 20 includes at least a substrate 40 and a film 42. As has been discussed above, luminescable medium 20 is a structure that is sensitive to gas such that one or more properties of the luminescence of luminescable medium 20 are impacted by the presence of one or more gaseous analytes. For example, in one embodiment, the intensity and/or persistence of the luminescence of luminescable medium 20 are impacted by the presence of the one or more gaseous analytes.

Substrate 40 provides a base upon which film 42 can be formed and/or deposited. As such, substrate 40 may be composed of any organic or inorganic material with a rigidity and surface characteristics that enable this functionality. Further, the material from which substrate 40 is composed should not substantially inhibit the luminescence of luminescable medium 20 and/or the transmission of luminescent radiation from luminescable medium 20 to the appropriate detector (e.g., sensor 12 in FIGS. 1-3). Accordingly, in one embodiment, substrate 40 is at least somewhat translucent to electromagnetic radiation provided to luminescable medium 20 to excite luminescence and/or electromagnetic radiation luminesced from luminescable medium 20. For example, substrate 40 may be substantially transparent to such electromagnetic radiation. In one embodiment, substrate 40 may include a sheet of substrate material that is separated into separate units (e.g., for use a system similar to that shown in FIGS. 1-3 and described above) after deposition of film 42 thereon.

Film 42 is composed of a polymer matrix that carries a dye. In one embodiment, the dye is sensitive to the one or more gaseous analytes, and the polymer matrix provides the structure that holds the dye in tact on substrate 40, thereby creating the gas sensitive structure that is luminescable medium 20. As is discussed further below, film 42 is formed to enable detection of concentrations of the one or more gaseous analytes over an enhanced dynamic range at an enhanced response time.

The dye included in film 42 may include any gas sensitive luminescent dye (e.g., a fluorescent dye). Some non-limiting examples of such dyes include porphyrin based dyes, ruthenium based dyes, parylene based dyes, ion sensitive fluorophores (e.g., fluoroscein based dyes, pyrene based dyes, etc.), and/or other gas sensitive dyes. The dye may be selected such that the one or more gaseous analytes includes one or more of oxygen, carbon dioxide, anesthetic agents, and/or other gaseous compositions.

The polymer matrix in film 42 may be formed from any polymer (or combination of polymers) capable of immobilizing the dye. Some non-limiting examples of such dyes include methacrylates, silica aerogels, polycarbonates, polystyrenes, PVCs, vinyl pyrrolidones, polyesters, and/or other polymers. In some instances, the polymer used to form the matrix is at least partially translucent to (e.g., substantially transparent to) radiation provided to luminescable medium 20 to excite luminescence and/or luminescent radiation luminesced from luminescable medium 20 so as not to substantially inhibit the luminescence of luminescable medium 20 and/or the transmission of luminescent radiation from luminescable medium 20 to the appropriate detector. Instead of relying solely on the properties of the polymer used to form the polymer matrix of film 42 (e.g., degree of cross-linking, molecular weight, etc.) to enhance one or both of the dynamic range and/or the response time of luminescable medium 20, the polymer matrix of film 42 is formed with a structure designed to enhance these and/or other properties of luminescable medium 20.

As used herein, the term “dynamic range” refers to a range of concentrations of the one or more analytes that can be detected based on the luminescence of luminescable medium 20. Generally, the dyes used to form luminescable medium 20, outside of the polymer matrix, have a relatively low dynamic range. For example, if the dye were outside of the polymer matrix, or if the polymer matrix provided substantially unfettered access of the dye to ambient gases, all of the “positions” in the dye at which one or more gaseous analytes in the gases can access the dye to quench the luminescence may be saturated by a relatively low concentration of the one or more gaseous analytes.

Where the polymer used to form the polymer matrix does not inhibit that access of the one or more gaseous analytes to the dye, the presence of a concentration of the one or more gaseous analytes higher than this saturation point will not result in additional quenching. Instead, the higher concentration will be perceived by a sensor detecting quenching of the luminescence (e.g., sensor 12 shown in FIGS. 1-3) as the same, relatively low, concentration of the one or more gaseous analytes that saturated the dye of film 42, resulting in inaccurate measurements by the sensor of the concentration of the one or more gaseous analytes.

In order to avoid this saturation, a polymer is selected for forming the polymer matrix that has a degree of cross-linking and/or molecular weight that permits diffusion of the one or more gaseous analytes into the matrix. The diffusion of the one or more gaseous analytes through the polymer of the polymer matrix to access the dye further increases the dynamic range of luminescable medium 20 because the diffusion of the one or more gaseous analytes will be a function of the concentration of the one or more gaseous analytes. In one embodiment, the polymer matrix is formed with a polymer having a degree of cross-linking and/or molecular weight such that the dynamic range of luminescable medium 20 is at least from about 20% to about 90% concentration of the one or more gaseous analytes. In one embodiment, the polymer matrix is formed with a polymer having a degree of cross-linking and/or molecular weight such that the dynamic range of luminescable medium 20 is at least from about 20% to about 95%. In one embodiment, the polymer matrix is formed with a polymer having a degree of cross-linking and/or molecular weight such that the dynamic range of luminescable medium 20 is at least from about 20% to about 100%.

Generally, where the polymer of the polymer matrix is selected for having a degree of cross-linking and/or molecular weight that results in a relatively large dynamic range for luminescable medium 20, the diffusion process of the one or more gaseous analytes through the polymer matrix to access the dye over the dynamic range will also impact the time it takes for molecules of the one or more gaseous analytes to come into contact with the dye (e.g., as the one or more analytes diffuse through the matrix). More specifically, the time it takes for molecules to reach the dye will be increased, which, in turn, will increase a delay between a change in the concentration of the one or more gaseous analytes in a body of gas in communication with luminescable medium 20 and the corresponding change in the amount of quenching provided by the one or more gaseous analytes. For the purposes of this disclosure, this delay will be referred to as the “response time” of luminescable medium 20.

A more specific, non-limiting, example of a definition of response time is the time it takes for the signal provided by luminescable medium 20, in response to a change in concentration of the one or more gaseous analytes, to go from some lower percentage of the change the signal will make in response to the change in concentration to some upper percentage of the change the signal will make in response to the change in concentration. In some instances, the lower percentage of the change in the signal may be defined as 10% of the change, and the upper percentage of the change in the signal may be defined as 90% of the change.

In embodiments in which the body of gas in communication with luminescable medium 20 is not subject to sudden changes in the concentration of the one or more gaseous analytes, or where a delay in detecting such changes is of marginal import, the delay in the response time caused by the diffusion of the one or more gaseous analytes into the polymer matrix of film 42 may not inhibit operation of a system including luminescable medium 20, e.g., as shown in FIGS. 1-3 and described above. However, in other embodiments, the concentration of the one or more gaseous analytes in the body of gas should be quantified (e.g., based on the luminescence of luminescable medium 20) with relatively minimal lag. In order to provide the enhancements of a polymer matrix described above (e.g., enhanced dynamic range), the polymer matrix of film 42 should form openings somewhat larger than the molecules of the one or more gaseous analytes. This may increase the effective surface area of the polymer matrix and dye, and maintain advantages associated with diffusion of the one or more gaseous analytes into the polymer matrix discussed above, while maintaining the response time of luminescable medium 20 below an acceptable threshold.

It should be appreciated that the acceptable threshold for the response time of luminescable medium 20 will be a function of the one or more gaseous analytes being monitored, the nature and/or composition of the body of gas, and/or the operational requirements of the system in which luminescable medium 20 is deployed to monitor the one or more gaseous analytes. Some non-limiting examples of the response time include about 90 milliseconds, about 80 milliseconds, and about 60 milliseconds. In some instances, the acceptable threshold for the response time of luminescable medium 20 will specify the response time over at least a portion of the dynamic range of luminescable medium 20. In some instances, the acceptable threshold for the response time of the luminescable medium 20 will specify the response time over substantially the entire dynamic range of luminescable medium 20.

From the foregoing it should be apparent that in designing film 42 there is a tension between the dynamic range of luminescable medium 20 and the response time of luminescable medium 20, i.e., as the dynamic range is increased through the selection of different polymers for the polymer matrix, the response time decreases, and vice versa, etc. As was mentioned above, conventionally, the dynamic range and response time of film 42 have been primarily a function of parameters of the polymer used to form film 42, such as the degree of cross-linking and the molecular weight. The porosity of the polymer matrix in film 42 described above enables polymers to be implemented in film 42 that would not have been suitable in conventional luminescable media (e.g., due to relatively large response time of the resulting film) to enable a relatively large dynamic range while maintaining an acceptable and/or enhanced response time. In this embodiment, the reciprocal restrictions placed on the dynamic range and response time of luminescable medium 20 may be relaxed over a conventional, substantially non-porous luminescable medium. Further, different combinations of porosities and/or polymers (with different polymer parameters) may facilitate greater customization in the inherent trade-off between the dynamic range and response time than is available by simply switching between different polymers in a conventional, non-porous luminescable medium.

In one embodiment, to provide the polymer matrix (and included dye) of film 40 on substrate 42, the polymer matrix and dye may be applied to substrate 42 as a series of droplets with a solvent having a low boiling point, e.g., to enable the solvent to be evaporated out of the matrix after deposition. For example, coating processes such as sputtering, spin coating, vapor deposition, spraying and/or other coating processes. The porosity of the matrix, the size of the openings formed by the matrix, and/or other properties of the matrix may be controlled by adjusting the parameters of the coating process. It should be appreciated that the formation of film 42 on substrate 40 is not intended to be limiting. In some instances, film 42 may be formed with the appropriate porosity separately from substrate 40, and then may be mounted to substrate 40, e.g., with an adhesive, etc. In one embodiment, the polymer matrix is formed with a porosity greater than about 10%. In one embodiment, the polymer matrix is formed with a porosity of greater than about 12%.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A component of a system configured to monitor one or more gaseous analytes, the component comprising:
(a) a conduit formed to enable a flow of gas therethrough;
(b) a gas sensitive film disposed in communication with the flow of gas, the film being sensitive to one or more gaseous analytes within the flow of gas, the film comprising:
(1) a dye that is sensitive to the one or more gaseous analytes; and
(2) a polymer matrix carrying the dye, wherein the polymer matrix is porous, having a porosity greater than 10% and openings greater than a molecular diameter of molecules of the one or more gaseous analytes to increase an effective surface area of the polymer matrix and to enable and maintain (i) a dynamic range of at least from about 20% to about 90% concentration of the one or more gaseous analytes, and (ii) a response time over at least a portion of the dynamic range of less than about 80 milliseconds, wherein the dynamic range refers to the range of concentrations of the one or more gaseous analytes that can be detected based on a luminensce of the dye, and wherein the dye, by itself of the polymer matrix, has a low dynamic range.

2. The component of claim 1, wherein the response time of the film from about 20% to about 90% concentration of the one or more gaseous analytes is less than about 60 milliseconds.

3. (canceled)

4. The component of claim 1, wherein the dye is luminescent, and wherein one or more properties of the luminescence of the dye are impacted by the presence of the one or more gaseous analytes.

5. The component of claim 4, wherein an intensity and/or persistence of the luminescence of the dye are impacted by the presence of the one or more gaseous analytes.

6. The component of claim 1, wherein one or both of the polymer matrix and/or a substrate of the gas sensitive film are at least translucent to electromagnetic radiation luminesced by the dye.

7. The composition of claim 1, wherein the one or more gaseous analytes comprise oxygen.

8. A gas sensitive structure, the structure comprising:
(a) a substrate; and
(b) a film disposed on the substrate, wherein the film is sensitive to one or more gaseous analytes, the film comprising:
(1) a polymer matrix having a porosity greater than 10%; with openings greater than a molecular diameter of molecules of the one or more gaseous analytes, to increase an effective surface area of the polymer matrix and to enable and maintain (i) a dynamic range of at least from 20% to 90% concentration of the one or more gaseous analytes, and (ii) a response time over at least a portion of the dynamic range of less than 90 milliseconds; and
(2) a dye carried by the polymer matrix, wherein the dye is sensitive to the one or more gaseous analytes, wherein the dynamic range refers to the range of concentrations of the one or more analytes that can be detected based on a luminensce of the dye, and wherein the dye, by itself outside of the polymer matric, has a low dynamic range.

9. The structure of claim 8, wherein the dye is luminescent, and wherein one or more properties of the luminescence of the dye are impacted by the presence of the one or more gaseous analytes.

10. The structure of claim 9, wherein the dye luminesces electromagnetic radiation at a first wavelength in response to being exposed to electromagnetic radiation at a second wavelength.

11. The structure of claim 10, wherein one or more properties of the electromagnetic radiation luminesced by the dye at the first wavelength is impacted by the presence of one or more gaseous analytes.

12. The structure of claim 9, wherein an intensity and/or persistence of the luminescence of the dye are impacted by the presence of the one or more gaseous analytes.

13. The structure of claim 8, wherein one or both of the polymer matrix and/or the substrate are at least translucent to electromagnetic radiation luminesced by the dye.

14. The structure of claim 8, wherein the one or more gaseous analytes comprise oxygen.

15. A gas sensitive structure, the structure comprising:
(a) a substrate; and
(b) a film disposed on the substrate, wherein the film is sensitive to one or more gaseous analytes, the film comprising:
(1) a dye that is sensitive to the one or more gaseous analytes; and
(2) a polymer matrix carrying the dye, wherein the polymer matrix is farmed porous, having a porosity greater than 10% and openings greater than a molecular diameter of molecules of the one or more gaseous analytes, to increase an effective surface area of the polymer matrix and to enable and maintain (i) a dynamic range of at least from about 20% to about 90% concentration of the one or more gaseous analytes, and (ii) a response time over at least a portion of the dynamic range of less than about 80 milliseconds wherein the dynamic range refers to the range of concentrations of the one or more gaseous analytes that can be detected based on a luminensce of the dye, and wherein the dye, by itself, outside of the polymer matrix, has a low dynamic range.

16. The structure of claim 15, wherein the response time of the film from about 20% to about 90% concentration of the one or more gaseous analytes is less than about 60 milliseconds.

17. (canceled)

18. The structure of claim 15, wherein the dye is luminescent, and wherein one or more properties of the luminescence of the dye are impacted by the presence of the one or more gaseous analytes.

19. The structure of claim 18, wherein the dye luminesces electromagnetic radiation at a first wavelength in response to being exposed to electromagnetic radiation at a second wavelength.

20. (canceled)

21. The structure of claim 18, wherein an intensity and/or persistence of the luminescence of the dye are impacted by the presence of the one or more gaseous analytes.

22. The structure of claim 15, wherein one or both of the polymer matrix and/or the substrate are at least translucent to electromagnetic radiation luminesced by the dye.

23. The structure of claim 15, wherein the one or more gaseous analytes comprise oxygen.
